(19) United States
(12) Patent Application Publication
(10) Pub. No.: US 2002/0098001 A1
(43) Pub. Date: Jul. 25, 2002

(54) Large scale electronic display combined with an interactive terminal

(76) Inventor: Andrew A. Dahl, Bloomfield Hills, MI (US)

Correspondence Address: John R. Benefiel, Suite 100 B, 280 Daines Street, Birmingham, MI, 48009, US

(21) Appl. No.: 09/976,683

(22) Filed: Oct. 11, 2001

Related U.S. Application Data
(60) Provisional application No. 60/239,513, filed on Oct. 11, 2000.

(51) Int. Cl. G03B 17/48

(52) U.S. Cl. 396/429

(57) ABSTRACT

A kiosk having an electronic billboard video display which display is switched to a reduced area display associated with an interactive terminal in the kiosk. Chromogenically activated privacy panels are rendered opaque when the terminal is in use to block viewing of the reduced area display.

### CROSS REFERENCE TO RELATED APPLICATION

This application claims the benefit of U.S. provisional serial No. 60/239,513, filed Oct. 11, 2000.

### INCORPORATION BY REFERENCE

The computer program listing appendix on the accompanying compact discs of computer program listing appendix labeled copy 1 and copy 2, each containing the file WEB BILLBOARD 1.0 created on Oct. 9, 2001, each containing 13,100 bytes is hereby incorporated by reference to form a part of this specification. This file comprises a suitable source code to be loaded in the interactive terminal computer to carry out the various functions described herein.

### BACKGROUND OF THE INVENTION

Large scale billboards are often used in high traffic public places such as airports, malls, plazas, etc for commercial advertising. Electronic displays are sometime used for this purpose, exhibiting large scale video images, either still frame or fall motion videos to be eye-catching and to have maximum commercial impact.

Public interactive terminals are also in widespread use at such locations for obtaining information, such as for hotels, restaurants, etc., or conducting internet transactions, frequently housed in kiosks mounting fixed advertising graphics.

It is costly to have such large scale electronic displays in these locations due to the high expense incurred for rental of the space and for the hardware necessary to display full motion videos and the need to maintain and periodically update the displays. On the other hand, the commercial value of the great public exposure of displays located in these locations is high.

It is the object of the present invention to provide a large scale electronic display which is combined with an interactive terminal to maximize the usage of the display hardware to improve its cost effectiveness and to enhance its commercial value by providing other modes of commercial promotion.

Another object of the invention is to reduce the cost of maintaining and updating a large scale electronic display.

### SUMMARY OF THE INVENTION

The above object and others, which will become apparent upon a reading of the following specification and claims, are achieved by mounting an electronic billboard comprised of a large scale electronic display screen to a kiosk or booth so as to exhibit an image readily viewable by persons at some distance from the kiosk. A lower section of the electronic display screen lies immediately above an interactive terminal in the kiosk, with chromogenic privacy panels extending alongside the terminal to block viewing of the lower section of the screen but only when there is a person using the interactive terminal so that the entire display is normally viewable by passersby.

The display screen normally exhibits a large scale image for viewing by all persons in the general area of the kiosk, an interactive terminal computer having a stored video signal transmitted to the electronic display.

An approach within a short distance by an interested person is detected by a short range motion-proximity sensor, which causes the computer to change the large scale image to a display image having a message inviting use of the interactive terminal. When a person steps up to the terminal and touches a keyboard, touch pad or a touch screen comprised of the lower section of the screen, the computer causes a display image from the interactive terminal to be exhibited confined to the lowermost section of the screen, and also causes the chromogenic panels to be rendered opaque. The interactive terminal is controlled by a touch screen capability of the electronic display, or by a keyboard, touch pad or mouse, or by manipulation of combinations of the same, to allow stored information to be accessed and/or internet transactions or data access to be enabled. The internet connection can also be used to change or update the video signal data in th computer to modify the large scale and interactive terminal displays from a remote location.

### DESCRIPTION OF THE DRAWING FIGURES

FIG. 1 is a perspective view of a kiosk according to the present invention equipped with a large scale electronic display screen and an interactive terminal.

FIG. 2 is a downward looking diagrammatic representation of the large display screen and interactive terminal together with other related components and connections.

FIG. 3 is a front view of a typical screen display during the interactive mode.

FIG. 3A is an enlarged view of the interactive terminal screen display.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

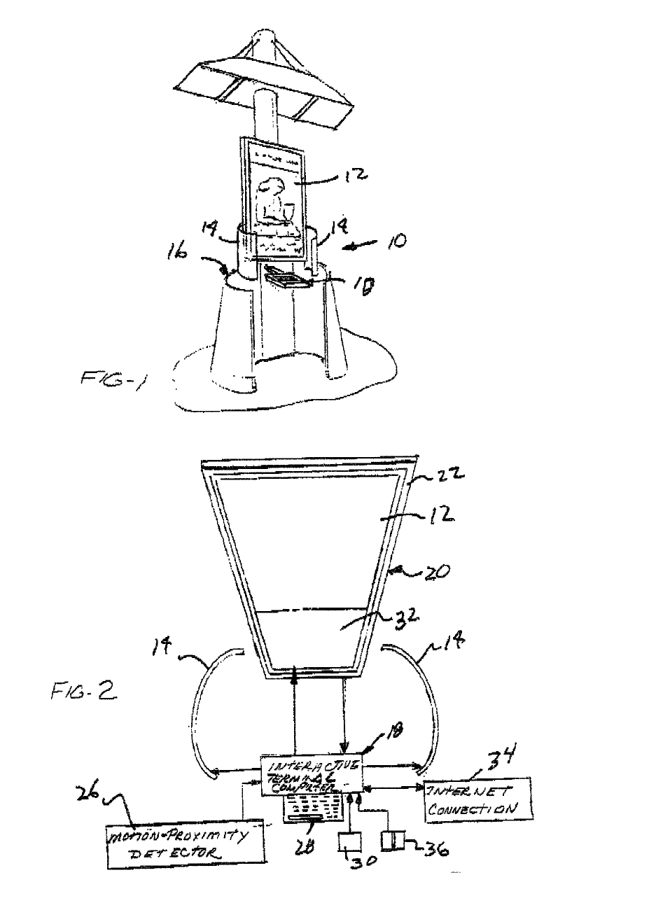

Referring to the Drawings, and particularly FIG. 1, a kiosk or booth 10 is shown which has a base 16 mounting a large scale electronic display 12 held upright for viewing of images comprising a full motion video, or changing still pictures which can be readily viewed by passersby at some distance, thereby functioning as an electronic billboard.

A pair of normally transparent chromogenic privacy panels 14 project from each side of the lower section of the electronic display 12 to define a privacy space therebetween when the panels 14 are rendered opaque by an electrical circuit.

An interactive terminal computer 18 is located below and in front of the electronic display 12 within the privacy space between the panels 14.

The terminal computer 18 can be a conventional IBM compatible PC using a Windows 2000 operating program, of suitable speed and other capabilities to be able to exhibit desired displayed images.

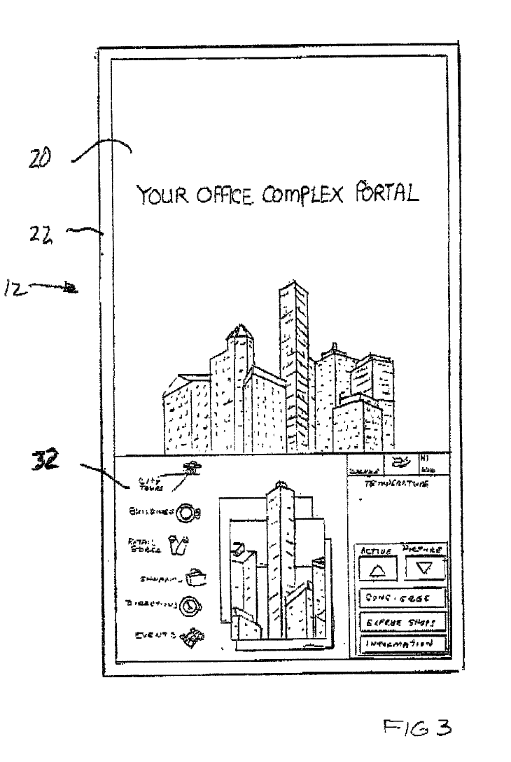

FIG. 2 is a diagrammatic representation of the large area electronic display 12, interactive terminal computer 18 and related system components.

The electronic display 12 is preferably a plasma panel display (PDP) 20, and preferably can be used as a touch screen by means of a touch system 20 surrounding the electronic display 12. The touch system 20 is comprised of a frame 22 containing an array of LED's and electronics allowing a user to interact with the interactive terminal computer 18. A suitable such system is available from Imaging Systems Technology (IST) of Toledo, Ohio, under the Touch Screen trade name.

As noted, the electronic display 12 is quite large to exhibit images readily viewable at a considerable distance, i.e., a screen size on the order of a 52 inches diagonal is preferable although smaller sizes such as 42 inches diagonal may be adequate.

A video display signal is received by the PDP from the computer 18, the PDP connected to the monitor part, which causes a full motion or a changing still image to normally be exhibited, which in a first mode occupies the entire area of the display 12, the lower section thereof viewable through the normally transparent panels 14.

A motion-proximity detector 26, which may be comprised of a downwardly aimed conventional motion detector, produces a signal when a passerby approaches, approximately within three feet, causing a second displayed image to be exhibited containing a message inviting interactive use.

The motion-proximity sensor 26 is connected to the computer 18 as to a serial port, with a suitable signal conversion, as by use of a relay, so as to be compatible with the computer in any manner well known to those skilled in the art.

When the passerby steps up to the terminal 18 and interacts therewith, as by pressing a key on a keyboard 28, or contacting a touch pad 30 (or mouse), or touches the electronic display 12, the display is switched to a second mode, in which interactive terminal images are exhibited on the lower section 32 of the display 12 within the space between the privacy panels 14. At the same time, the panels 14 are rendered opaque by a control signal from the computer 18 causing and electrical circuit to be operated to cause the panels 14 to become partially or wholly opaque to block viewing of the lowermost section 32 by persons not within the privacy space between the panels 14.

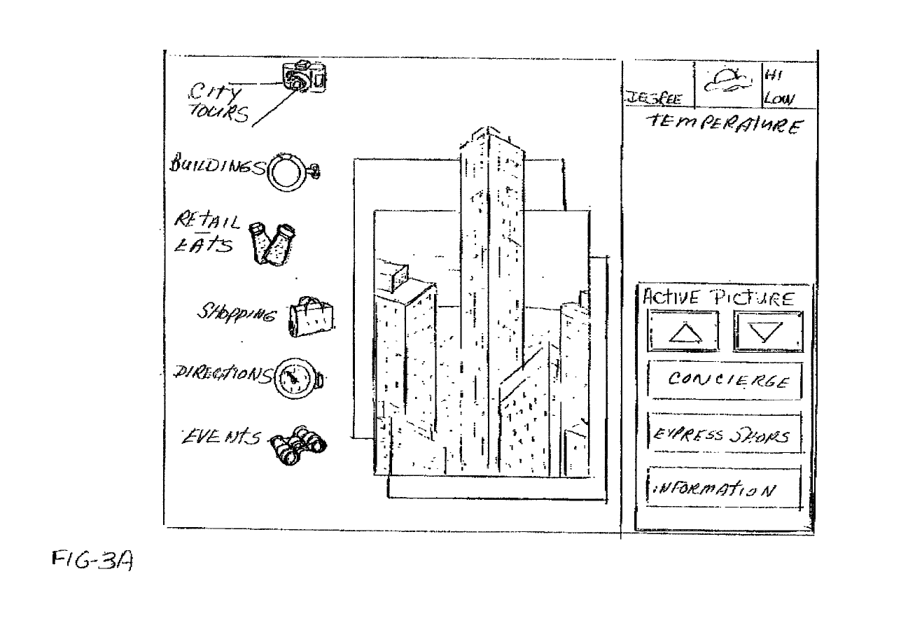

Other images can be exhibited at this time on the upper section of the display 12, as shown in FIG. 3.

Such chromogenic panels can be constructed in various ways, such as by applying a special electrochromic film to glass panels, which film is normally transparent but which becomes opaque when a current is applied (or removed). See U.S. Pat. Nos. 6,266,177; 6,245,262; and 6,039,390 for examples of these films. Other chromogenic devices such as liquid crystal and thermotropic devices are described in Project B3 Final Report. Task 18 by Mike Rubin of the Lawrence Berkley National Laboratory, published in 1997 by IEA.

A card swipe reader 36 is also connected to the computer 18 for executing internet transactions.

FIG. 3 shows a typical interactive display contemplated, as for example providing information and/or transactions in a large office building.

An image in the upper region of the display can remain while the interactive terminal is in use.

Transactions and data transfers may be executed via the internet connection 34, in response to input from the interactive terminal computer 18.

In addition, the display images can be updated or changed from a remote location.

A thermal printer 38 can also be connected to allow confirming copies of transaction details.

The user can control the session variously by the touch screen capability, the keyboard or the touch pad. Access to various hard drive content features regarding products, retail store locations, miscellaneous relevant information, etc. is also thereby enabled.

By connection to the internet, commercial web sites of advertisers can be contacted where user transactions may be enabled.

When the user ends his or her session, and steps away, the display 12 clears, and a full scale image is again exhibited.

A typical computer program is set forth in the source code listing contained on the compact disc appendix referenced above, although it should be noted that a mouse signal has been substituted therein for the motion-proximity sensor signal contemplated.

1. The combination of a display with an interactive terminal comprising:
a large area electronic display able to exhibit large scale images viewable at substantial distances by passers by, said display mounted on a base;
an interactive terminal computer having at least one peripheral device enabling interactive access to store data in said interactive terminal computer;
such display connected to said computer which generates signals alternatively producing a display image occupying the complete area of said electronic display in one mode, and in another mode, generating display images confined to a lower section of said electronic display;
said interactive terminal computer having at least one peripheral connected thereto enabling interactive use by reference to said display image confined to said lower section of said electronic display.

2. The combination according to claim 1 further including a pair of screen panels, each mounted on a respective side of said lower section of said electronic display.

3. The combination according to claim 2 wherein said screen panels are electronically changeable from a transparent to an opaque state, said panels electronically controlled by said computer to be opaque during use of said interactive terminal computer.

4. The combination according to claim 1 wherein said electronic display is capable of a touch screen function, to at least partially enable control of said interactive terminal computer.

5. The combination according to claim 4, further including a keyboard for control of said interactive terminal computer.

6. The combination according to claim 1 further including an internet connection to said interactive terminal computer.

7. The combination according to claim 6 wherein video signals for exhibiting said one mode display images on said complete area of said electronic display are loadable into said computer via said internet connection.

8. The combination according to claim 1 further including a motion-proximity detector generating a signal upon approach of a passerby to a predetermined closeness, said computer responsive thereto to modify a display image normally exhibited by said electronic display.

9. The combination according to claim 1 wherein said electronic display is switched from said one mode to said other mode upon initial use of an interactive terminal computer peripheral device.

10. The combination according to claim 8 wherein said normal display is resumed upon retreat of any passerby away from said kiosk.

11. A method of using an electronic display both as an electronic billboard and as a display for an interactive terminal comprising the step of exhibiting a large scale image on a large area electronic display;
coupling an interactive terminal computer to said electronic display; and
switching to a reduced area display exhibited by a portion of the area of said electronic display comprising displays generated by interactive terminal computer.

12. The method according to claim 11 further including the step of activating chromogenic privacy panels arranged to create a privacy space adjacent said portion of said electronic display.

13. The method according to claim 11 further including the step of periodically changing said display image from video data transmitted via an internet connection.

14. The method according to claim 11 further including the step of changing said display image in response to the approach of a passerby to the vicinity of said interactive terminal computer.
